(19) United States
(12) Patent Application Publication
(10) Pub. No.: US 2021/0178524 A1
(43) Pub. Date: Jun. 17, 2021

(54) METHOD FOR PRODUCING A TUBULAR FRAME

(71) Applicant: JENOPTIK Automatisierungstechnik GmbH, Jena (DE)

(72) Inventors: Sebastian STEINBACH, Jena (DE); Torsten SCHELLER, Jena (DE); Markus REMM, Magdala (DE); Torsten REICHL, Jena (DE); Jan LANGEBACH, Gera (DE)

(21) Appl. No.: 16/770,518

(22) PCT Filed: Dec. 5, 2018
(86) PCT No.: PCT/DE2018/100990

§ 371 Date: Jun. 5, 2020

(30) Foreign Application Priority Data
Dec. 7, 2017 (DE) 102017129106.7

(51) Int. Cl. B23K 26/38; B23K 26/03

(52) U.S. Cl. CPC B23K 26/38; B23K 26/0861; B23K 26/032

(57) ABSTRACT

A method that makes it possible to produce actual cutting contours on tubes with only rough tolerances, to which contours others of the tubes can be joined and welded, wherein, as a result of the actual cutting contours being modified, the rough shape tolerance of the tubes does not enter the tolerance chain, or enters the latter only a little, for the tubes to be fully welded to form a tubular frame. It also allows the automated reception of only pre-oriented tubes by a gripping arm and the infeed thereof to a laser cutting device.

### PRIORITY CLAIM

The present application is a National Phase entry of PCT Application No. PCT/DE2018/100990, filed Dec. 5, 2018, which claims priority from German Patent Application 10 2017 129 106.7, filed Dec. 7, 2017, the disclosures of which are hereby incorporated by reference herein in their entirety.

### FIELD OF THE INVENTION

The invention relates to tubular frames. More specifically, the invention relates to methods and systems for advantageously producing tubular frames.

### BACKGROUND OF THE INVENTION

Tubular frames constitute a metal construction consisting of a large number of individual tubes that are joined together, e.g. by welded joints. Compared to frames made of solid profiles, tubular frames, while having the same tensile strength, are characterized by a more favorable ratio of mass to strength and are therefore used in particular where load-bearing structures with only a low weight are required.

In order to form a desired construction, the tubes must be welded together in a specified relative position. This creates joints at interfaces, each of said joints being formed by two joining surfaces on the tubes. The two joining surfaces usually each represent a cutting contour made for this purpose on one of the tubes and a fitted shell surface on another of the tubes or another cutting contour made for this purpose on another of the tubes. A cutting contour can be produced by cutting out or cutting off a tube.

The disadvantage of manufacturing a tubular frame from partially bent tubes with a circular cross section is the large variation in the bending radius for identical tubes due to production, which means that the individual tubes have a comparatively low dimensional accuracy in terms of the line of their tube axes.

Two different methods for trimming bent tubes or tube-like components (hereinafter jointly referred to as tubes) are known from the prior art. The two methods can be automated using a laser as the cutting tool.

In a first method known from practice, reference holes are formed in the tube before the cutting process step. Via these holes, the tube is received in a workpiece receptacle in order to position the tube with respect to the cutting tool. This holds the tube with a predetermined relative position of the reference holes to the workpiece receptacle. In automated cutting, the cutting contours along which the tube is cut are defined in terms of their spatial position relative to the position of the reference holes, regardless of a possible tolerance deviation of the tube bend from a desired value. The position of the reference holes is selected in such a way that a tube which can be fitted while in the receptacle is also within a specified tolerance range for the tube bend. This means that the criterion of the tube fitting or not also determines whether the tube is in or out of tolerance. Due to the geometric tolerances of the tubes, a defined automated pick-up by a gripper and fitting via the reference holes in the workpiece receptacle is not possible.

In a second method known from practice, the tube is inserted in a workpiece receptacle in which the tube comes to rest within a contact area. Again, the tubes must be inserted manually due to their geometric tolerances. Tubes that cannot be inserted to a specified extent have a bending radius which deviates from a desired value to such an extent that the tube bend no longer lies within a specified bending tolerance. A disadvantage in this case is, on the one hand, that due to the fixed position of the tube in the workpiece receptacle, the tube is accessible for a cutting tool such as a laser beam only to a limited extent. Areas concealed by the workpiece receptacle on the tube only become accessible for machining when the tube is moved to another workpiece holder. This leads to an increased expenditure of time and equipment. On the other hand, out-of-tolerance deviations in the shape of the tube outside the contact area of the receptacle are not detected, which may result in a cutting contour being cut out-of-tolerance on a tube and such a faulty tube being fed for further processing without being identified as faulty.

Especially in the manufacture of complex welded assemblies, such as tubular frames, it is particularly disadvantageous if it is not detected until the later process step of welding the tubes that the tubes cannot be joined together at all interfaces because the cutting contours on individual tubes deviate too far from a specified desired position and the resulting deviations in the spatial position of the tubes relative to each other accumulate within a tolerance chain.

### SUMMARY OF THE INVENTION

It is the object of the invention to provide a method for producing a tubular frame that is comparatively more automated and advantageously shortens the tolerance chain to be observed for the production.

This object is achieved by a method for manufacturing a tubular frame consisting of a plurality of tubes that are welded together at several actual interfaces, via two joining surfaces each. At least one of the two joining surfaces represents an actual cutting contour along which one of the two tubes to be welded to each other was cut out or cut off with a laser beam before welding. A tolerance envelope is calculated for each individual tube and stored with reference to a coordinate system related to a feeding means. A desired cutting contour pattern with desired cutting contours, which are each assigned to one of the actual cutting contours, is defined for the tubular frame and the desired cutting contours are stored in relation to the tolerance envelopes of the individual tubes.

In each case one of the tubes is picked up by the feeding means with a gripping arm and transported relative to an optical measuring device, which assumes a known spatial position in the coordinate system, where the tube is optically recorded and measured. The gripping arm moves the tube spatially until the tube lies within the tolerance envelope calculated for this tube. At the same time or thereafter, the feeding means feeds the tube to a laser cutting device relatively in such a way that the tolerance envelope calculated for the tube assumes a predetermined position relative to the laser cutting device, whereby the tube has assumed a spatial position defined by a spatial position of the tolerance envelope relative to the laser cutting device.

The laser beam of the laser cutting device delineates the desired cutting contour related to the tolerance envelope, with the actual cutting contour being cut on the tube. The actual cutting contour corresponds to a projection of the desired cutting contour onto the tube.

The actual cutting contour is either in the form of a cutout area or of an end face.

The actual cutting contour in the form of a cutout surface in a shell of one of the tubes corresponds, for the tubes inserted in the same tolerance envelope with different tolerance deviations, to a differently modified image of the desired cutting contour, so that the other of the tubes welded to said actual cutting contour assumes the same relative position to the tolerance envelope of the inserted tube, regardless of the position of the inserted tube in the tolerance envelope.

The actual cutting contour in the form of an end face of one of the tubes assumes a different angle with a tube axis of the tube for the tubes with different tolerance deviations inserted into the same tolerance envelope, so that the other of the tubes welded to said actual cutting contour assumes the same relative position to the tolerance envelope of the inserted tube, regardless of the position of the inserted tube in the tolerance envelope.

It is advantageous not to feed the tube to the laser cutting device if the tube cannot be fitted into the tolerance envelope, which is a criterion for the tube being out of tolerance.

In order to connect the tubes to form a tubular frame as intended, they are welded together at interfaces (hereinafter referred to as actual interfaces). Each actual interface is defined by the position of a real cutting contour (hereinafter referred to as actual cutting contour), which is created by cutting out or cutting off one of the tubes. The resulting actual cutting contour, in the form of a cut-out area on the shell of the tube or an end face at the end of the tube, is respectively joined and welded to the shell or a cut end face of another of the tubes.

It is essential to the invention that for cutting the actual cutting contour the laser beam is not guided in relation to the real tube, but the laser beam is guided along the desired cutting contour which is related to the tolerance envelope calculated for the tube concerned. The desired cutting contour preferably lies within the tolerance envelope, preferably in the middle between the positions of two maximally deviating actual cutting contours on the tubes inserted in the tolerance envelope. In this case, the actual cutting contour forms as a projection of the desired cutting contour onto the real tube. Depending on the angular position of the laser beam in relation to the perpendicular at the points of incidence along the desired cutting contour, the desired cutting contour is projected onto the shell of the tube in a reduced, enlarged or otherwise modified manner. Ideally, the projection is performed in such a way that the other tube applied to the resulting actual cutting contour with its shell surface always has the same relative position to the tolerance envelope of the cut tube, completely independent of how the cut tube lies in the tolerance envelope. Thus, the positional tolerance of the tubes lying in the tolerance envelope does not enter into a tolerance chain.

The individual tolerance envelope is calculated for each tube, which is decisive for the shape tolerance of the respective tube and is stored in relation to a spatially fixed coordinate system, together with the desired interfaces of a desired interface pattern which are respectively assigned to the tolerance envelope. The tube then picked up for processing is fed to a 3-D camera. The tube is measured three-dimensionally and by moving the gripping arm holding the tube, the tube is inserted into the calculated tolerance envelope. If insertion is not possible, the tube is out of tolerance. The tolerance envelope may also cover only one or more individual sections of the tube. Knowing the position of the tolerance envelope in space, the tube has a known spatial position and is relatively fed to the laser cutting device with this level of accuracy. This means that the real tubes do not assume a reproducible spatial position relative to the laser cutting device and thus to the laser beam guided through the cutting nozzle. However, a reproducible spatial position is assumed by the tolerance envelope.

The invention will be explained in more detail below with reference to an exemplary embodiment and drawings.

### BRIEF DESCRIPTION OF THE DRAWINGS

In the drawings:

FIG. 1a shows a tubular frame comprising four tubes in an exploded view;

FIG. 1b shows a representation of the assembled tubular frame according to FIG. 1a;

FIG. 1c shows a desired interface pattern for the tubular frame according to FIGS. 1a and 1b with reference to a coordinate system;

FIG. 2 shows the tubular frame according to FIG. 1 in an exploded view with tolerance envelopes for the tubes;

FIG. 3a shows an ideal tube ideally lying within the tolerance envelope;

FIG. 3b shows a faulty tube lying within the tolerance envelope;

FIG. 3c shows another faulty tube lying within the tolerance envelope;

FIG. 4a shows the relative position of a tube, which lies with its shell surface against the cutting contour of another tube;

FIG. 4b shows an ideal tube lying ideally within the tolerance envelope;

FIG. 4c shows a tube lying tilted in the tolerance envelope;

FIG. 4d shows another tube lying tilted in the tolerance envelope, and

FIG. 5 shows a schematic diagram of a device suitable for performing the method.

### DETAILED DESCRIPTION

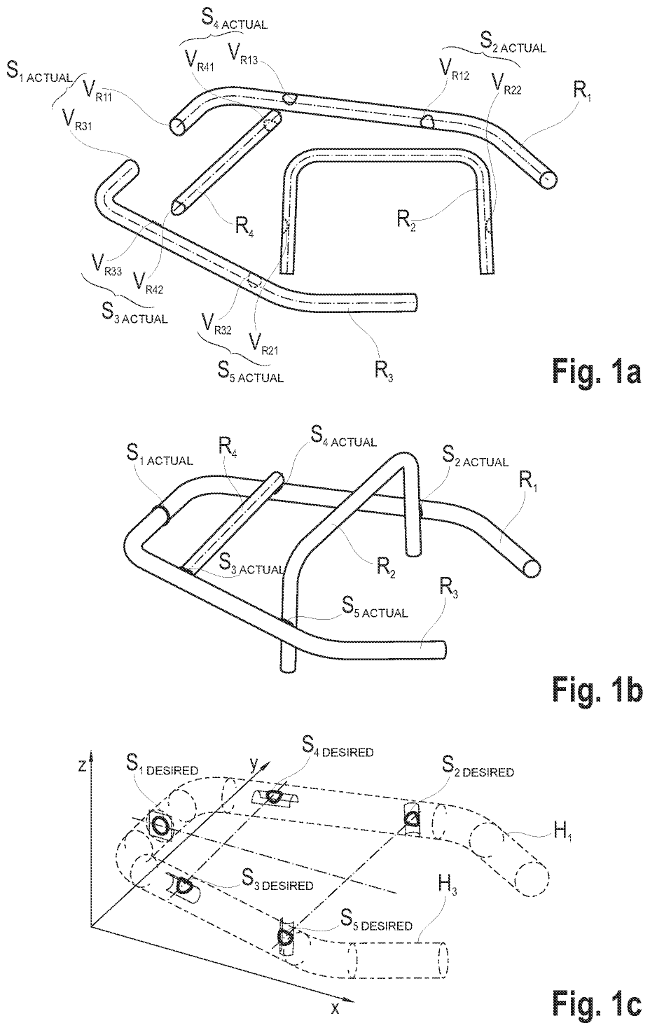

By way of example, FIG. 1a shows an exploded view of a tubular frame consisting of tubes R, in this case four tubes R₁-R₄, which are welded together at actual interfaces S_{ACTUAL}, i.e. five actual interfaces S_{ACTUAL1}-S_{ACTUAL5} in this specific case. The actual interfaces S_{ACTUAL1}-S_{ACTUAL5} are each formed by weldable joining surfaces V on the two tubes R, each forming a welding partner. FIG. 1b shows these four tubes R₁-R₄ welded together as intended. FIG. 1c shows a desired interface pattern with desired interfaces S_{DESIRED} for the tubular frame. Each of the desired interfaces S_{DESIRED} is assigned to one of the actual interfaces S_{ACTUAL}.

There are basically three different types of interfaces:

The first type of interface is obtained by pairing two tubes R via two end faces. An example of this is shown in FIGS. 1a-1b with reference to the actual interface S_{ACTUAL1}, where an end face of the tube R₃, as joining face V_{R31}, is welded to an end face of the tube R₁, as joining face V_{R11}.

The second type of interface is obtained by pairing two tubes R via a cutout surface and a shell surface. An example of this is shown in FIGS. 1a-1b with reference to the actual interface S_{ACTUAL2}, where a cutout surface of the tube R₁, as joining surface V_{R12}, is welded to the shell surface of the tube R₂, as joining surface V_{R22}.

The third type of interface is obtained by pairing two tubes R via an end face and a shell surface. An example of this is shown in FIG. 1 with reference to the actual interface S_{ACTUAL3}, where an end face of the tube R₄, as joining face V_{R42}, is to be welded to the shell surface of the tube R₃, as joining face V_{R33}.

Each of the interface types has at least one joining surface V, which represents a desired cutting contour K_{DESIRED}. According to the invention, their desired position of the latter is determined neither in relation to the ideal tube R nor to the real tube R, but rather in relation to a calculated tolerance envelope H. This tolerance envelope H envelops the ideal tube R. It also envelops the real tube R, whose external dimensions are in tolerance. The tolerance envelope H can also be defined for individual sections of individual tubes R.

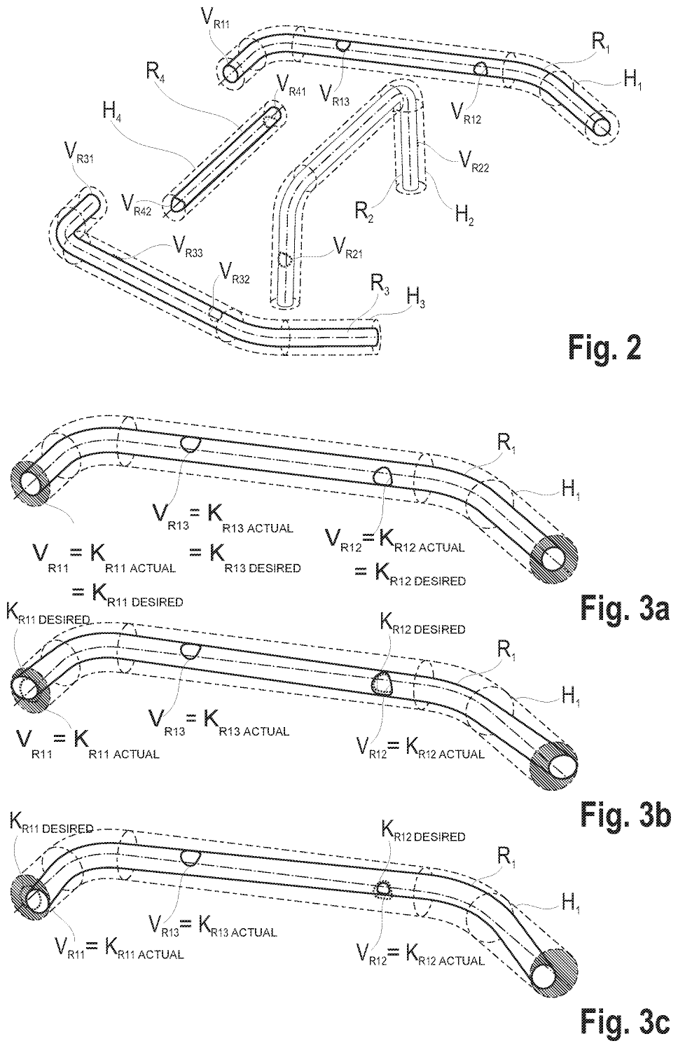

Prior to cutting the tubes R for the tubular frame, tolerance ranges for the dimensional accuracy of the shape of the relevant tubes R are calculated as the so-called tolerance envelopes H at least for the tubes R on which cutting is to be performed, see FIG. 2. Assuming that the tubes R are manufactured with sufficient accuracy in terms of their tube cross section and length, the possible shape deviation mainly concerns the deviation of the line of the actual tube axis from a desired tube axis due to the deviation of actual bending radii from desired bending radii on the tube R and a possible twisting of the actual tube axis in the bending areas.

Each actual interface S_{ACTUAL} is assigned the desired interface S_{DESIRED}, which is related to the tolerance envelope H, see FIG. 1b in combination with FIG. 1c. The desired interfaces S_{DESIRED} are stored in a desired interface pattern in a fixed relative position to each other. This means that the relative spatial position of the desired cutting contours K_{DESIRED} to each other is stored for the respective joining surfaces V to be produced by cuts.

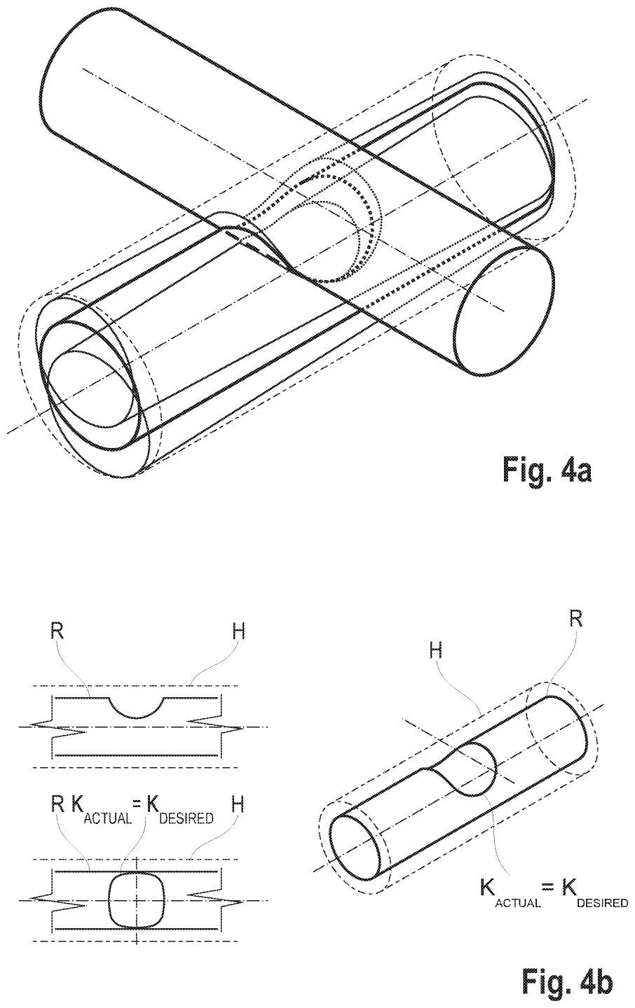

The tolerance envelopes H are each calculated in such a way that on each tube R fitting into the tolerance envelope H the actual cutting contours K_{ACTUAL} can be cut in such a way that the suitable joining surface V for welding is created. FIG. 3a shows the ideal tube R lying ideally within the tolerance envelope H. The tube axes of the ideal tube R and of the tolerance envelope H coincide. Advantageously, the desired cutting contours K_{DESIRED} are calculated in such a way that they coincide with the actual cutting contours K_{ACTUAL} in this case. This would no longer be the case if the ideal tube R were tilted within the tolerance envelope H.

FIGS. 3b and 3c show two tubes R₁, each fitting into the tolerance envelope H₁ and deviating differently from the shape of an ideal tube R₁. In relation to the tolerance envelope H₁, the desired cutting contours K_{R11DESIRED}, K_{R12DESIRED}, K_{R13DESIRED} have the same relative position to one another, but the actual cutting contours K_{R11ACTUAL}, K_{R12ACTUAL}, K_{R13ACTUAL} cut on the real tubes R₁, as shown in an exaggerated manner herein, have a slightly different spatial position and also a different shape and/or size. A cutout surface as joining surface V_{R12} for the actual interface S_{2ACTUAL} extends more or less deeply into tube R₁. An end face as joining face V_{R11} for the actual interface S_{1ACTUAL} is cut at different points along the tube axis of the tube R and at a different angle to the tube axis.

The tube R₃, in which an end face and a cutout surface are to be produced as joining faces V_{R31} and V_{R21} for the actual interfaces S_{1ACTUAL} and S_{5ACTUAL} respectively, is processed in the same way as the tube R₁.

On the tube R₄, only one end face is cut as joining surface V_{R42} for the actual interface S_{3ACTUAL}. The tolerance with respect to the second actual interface S_{4ACTUAL} is compensated by welding the tube R₄ with a moving part of its shell surface to a joining surface V_{R13}, which is a cutout surface.

The tube R₂ has no actual cutting contours K_{ACTUAL}. Its joining surfaces V_{R21}, V_{R22} are areas on shell surfaces whose relative position to each other is created during the production of the tube R. This means that in contrast to the joining surfaces V, which are created in different manners by cutting actual cutting contours K_{ACTUAL} on the tubes R due to the different position of the tube R in the tolerance envelope H, whereby the tolerances can be compensated, a tolerance deviation must be accepted here. Accordingly, either the tolerance envelope H must be kept sufficiently tight at least in the area of the joints V_{R21} and V_{R22}, or the tube R is designed in such a way that it is aligned with the joining surfaces V of the other tubes R by a positional adjustment. Specifically, the U-shaped tube R₂ is to be constructed here in such a way that its two arms do not run parallel to each other, but enclose a small angle with each other, allowing positional adjustment by shifting in the direction of the arms. After the tubes R₁ and R₂ have been welded together at the actual interface S_{1ACTUAL} and the tube R₄ has been welded on, the tube R₂ is inserted from above between the tubes R₁ and R₃ and welded so as to protrude upwards to a greater or lesser extent at the actual interfaces S_{2ACTUAL} and S_{5ACTUAL}.

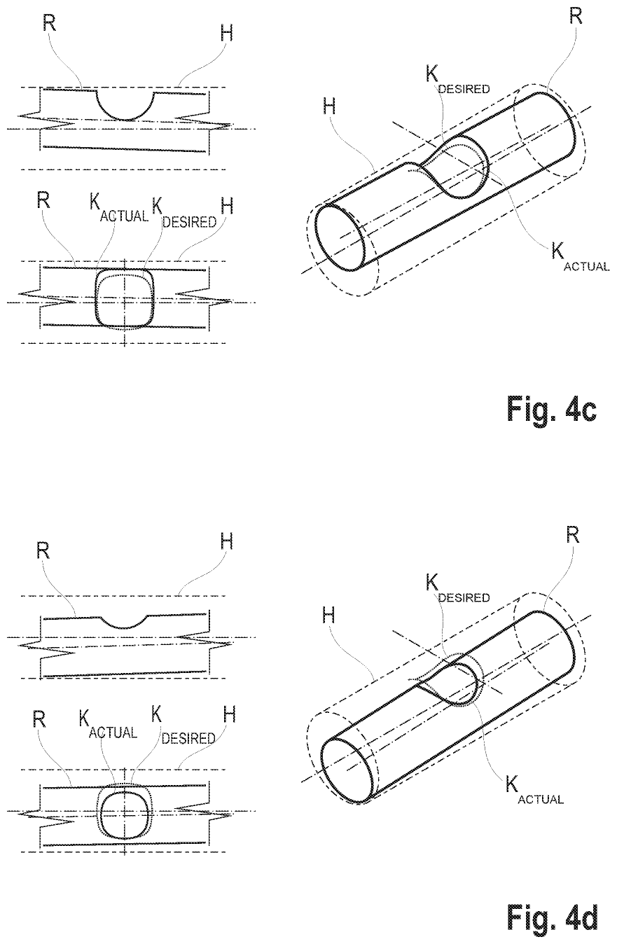

FIGS. 4b to 4d again show in simplified form, with reference to a straight tube R, how a desired cutting contour K_{DESIRED} is projected, in relation to a tolerance envelope H, onto the tubes R lying in the tolerance envelope H. Actual cutting contours K_{ACTUAL} projected onto the shell of the respective tube R are modified compared to the desired cutting contour K_{DESIRED} by a change in position, size and/or shape, depending on the spatial position of the shell of the respective tube R relative to the desired cutting contour K_{DESIRED}. The other of the tubes R, which is welded to the at least one actual cutting contour K_{ACTUAL}, has the same spatial position as shown in FIG. 4a with reference to three tubes R lying differently in the tolerance envelope H, as shown in FIGS. 4b- 4d.

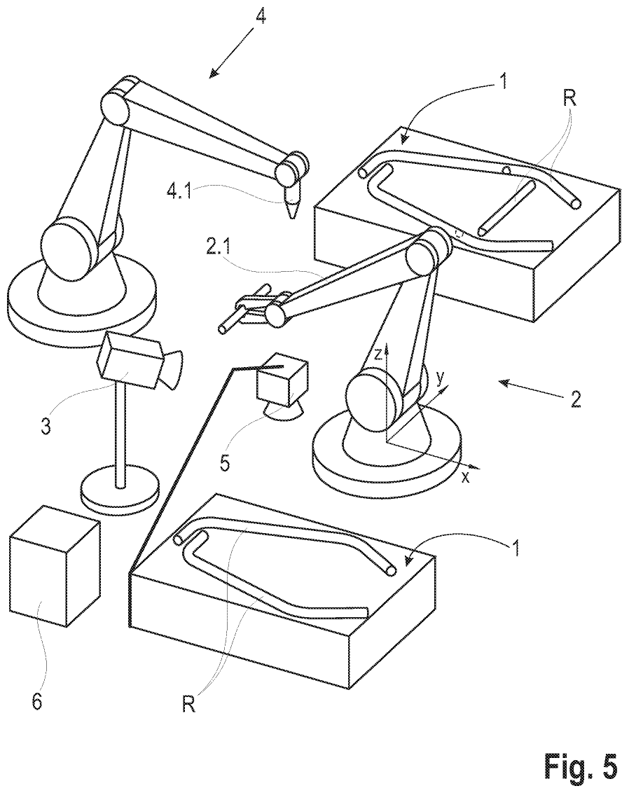

FIG. 5 shows a schematic diagram of a device suitable for carrying out the method. The device includes a feed surface 1, a feeding device, tube feeder or feeding means 2 with a gripping arm 2.1, an optical measuring device 3, e.g. a 3D camera, a laser cutting device 4 with a cutting nozzle 4.1, a storage and control unit 6 and advantageously a further optical measuring device 5. The latter is used to check whether there are one or several tubes R and how they are two-dimensionally aligned on the feed surface 1. Based on this knowledge, the gripping arm 2.1 can be adjusted, in order to grip the tube R optimally, in case of positional deviations from a desired position, which may also be due to a shape deviation of the tube R.

For machining the tubes R, i.e. for producing desired cutting contours K_{DESIRED}, the tubes R are each picked up from a feed surface 1 by the gripping arm 2.1 of the feeding means 2. Ideally, the tubes R lie pre-sorted, pre-positioned and pre-oriented on the feed surface 1, so that the gripping arm 2.1, moving to a predetermined gripping position, picks up the tube R, lying pre-oriented to the gripping arm 2.1. It is not necessary to position the tubes R so precisely on the feed surface 1 that they are picked up in a reproducible spatial position to the coordinate system of the feeding means 2, which also benefits the comparatively large shape tolerance of the individual tubes R.

The gripping arm 2.1 is preferably a multi-axis gripping arm 2.1, which can freely move a gripped workpiece, in this case the tube R, within a limited working area. Arranged within the working area are the feed surface 1, the optical measuring device 3 and the laser cutting device 4, each having a known spatial position within the coordinate system.

The gripping arm 2.1 transports the tube R to the optical measuring device 3, where the tube R is optically recorded and measured. Then, the tube R is inserted by the gripping arm 2.1 into a tolerance envelope H, thereby confirming that the tube R is in tolerance. The spatial position of the tube R within a coordinate system defined by the feeding means 2 is thus determined by the spatial position of the tolerance envelope H in the coordinate system.

Afterwards or at the same time, the gripping arm 2.1 feeds the tube R to the laser cutting device 4 in such a way that the tolerance envelope H is in a predetermined relative position to the laser cutting device 4. The laser cutting device 4 then cuts the actual cutting contours K_{ACTUAL} on the tube R, the laser beam being guided by the cutting nozzle 4.1 along a desired cutting contour K_{DESIRED} elated to the tolerance envelope H. The method can be performed using a laser beam because the execution of the cut does not require mechanical contact between a cutting tool and a workpiece and thus a defined position of the machining surface, as is the case with mechanical machining. In laser cutting, the machining surface can assume a different spatial position, at least within the focus range.

The method according to the invention makes it possible to produce the actual cutting contours K_{ACTUAL} on the only roughly tolerated tubes R, to which other tubes R can be attached and welded. By modifying the actual cutting contours K_{ACTUAL}, the rough tolerance of the tubes R is included only to a lesser extent, if at all, in the tolerance chain for the complete welding of the tubes R to a tubular frame. The method also enables the gripping arm 2.1 to automatically pick up the merely pre-oriented tubes R and feed them to the laser cutting device 4.

### LIST OF REFERENCE NUMERALS

R tube

S interface

S_{ACTUAL} actual interface

S_{DESIRED} desired interface

K_{ACTUAL} actual cutting contour

K_{DESIRED} desired cutting contour

V joining surface

H tolerance envelope

1 feed surface

2 feeding means

2.1 gripping arm

3 optical measuring device

4 laser cutting device

4.1 cutting nozzle

5 further optical measuring device

6 control and storage unit

1. A method for producing a tubular frame comprising a plurality of tubes which are welded together at several actual interfaces in each case via two respective joining surfaces, at least one of the two joining surfaces representing an actual cutting contour along which one of the two tubes to be welded in each case was cut out or cut off with a laser beam before welding, the method comprising
calculating a tolerance envelope for each individual tube of the plurality of tubes and storing the calculated tolerance envelope with reference to a coordinate system related to a tube feeder,
defining a desired cutting contour pattern with desired cutting contours, which are each assigned to one of the actual cutting contours, for the tubular frame and storing the desired cutting contours in relation to the tolerance envelopes of the individual tubes,
picking up one of the tubes in each case with a gripping arm of the tube feeder and transporting the tube relative to an optical measuring device with a known spatial position in the coordinate system, and optically recording and measuring the tube,
spatially moving the tube using the gripping arm until the tube lies within the tolerance envelope calculated for the tube,
feeding the tube using the tube feeder to a laser cutting device in such a way that the tolerance envelope calculated for the tube assumes a predetermined position relative to the laser cutting device, the tube having thus assumed a spatial position defined by a spatial position of the tolerance envelope relative to the laser cutting device, and
wherein the laser beam of the laser cutting device describes the desired cutting contour related to the tolerance envelope and the actual cutting contour is cut on the tube, the actual cutting contour corresponding to a projection of the desired cutting contour onto the tube.

2. The method for producing a tubular frame according to claim 1, wherein the actual cutting contour is in the form of a cutout surface in a shell of one of the tubes, which corresponds, for tubes inserted in the same tolerance envelope with different tolerance deviations, to a differently modified image of the desired cutting contour, so that another one of the tubes welded to the actual cutting contour assumes a same relative position to the tolerance envelope of the inserted tube, regardless of the position of the inserted tube in the tolerance envelope.

3. The method for producing a tubular frame according to claim 1, wherein the actual cutting contour is in the form of an end face of one of the tubes, which has a different angle with a tube axis of the tube for the tubes inserted into the same tolerance envelope with different tolerance deviations, so that a different one of the tubes welded to the actual cutting contour assumes a same relative position to the tolerance envelope of the inserted tube, regardless of the position of the inserted tube in the tolerance envelope.

4. (canceled)
